(19) United States
(12) Patent Application Publication
(10) Pub. No.: US 2007/0062594 A1
(43) Pub. Date: Mar. 22, 2007

(54) Microfluidic device with anisotropic wetting surfaces

(76) Inventor: Charles W. Extrand, Minneapolis, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/228,866

(22) Filed: Sep. 16, 2005

(51) Int. Cl. F15D 1/04

(52) U.S. Cl. 138/39

(57) ABSTRACT

A microfluidic device having durable anisotropic wetting fluid contact surfaces in the fluid flow channels of the device. The anisotropic wetting surface generally includes a substrate portion with a multiplicity of projecting regularly shaped microscale or nanoscale asperities disposed in a regular array on the surface. Each asperity has a first asperity rise angle and a second asperity rise angle relative to the substrate. The asperities are structured to meet a desired retentive force ratio (f₁/f₂) caused by asymmetry between the first asperity rise angle and the second asperity rise angle according to the formula: f₁/f₂=(ω₁+1/2Δθ₀)/sin(ω₂+1/2Δθ₀), Δθ₀=(θ_{a,0}−θ_{r,0}).

### FIELD OF THE INVENTION

This invention relates generally to microfluidic devices, and more specifically to a microfluidic device having anisotropic wetting fluid contact surfaces.

### BACKGROUND OF THE INVENTION

There has been much recent interest and effort directed to developing and using microfluidic devices. Microfluidic devices have already found useful application in printing devices and in so-called “lab-on-a-chip” devices, wherein complex chemical and biochemical reactions are carried out in microfluidic devices. The very small volumes of liquid needed for reactions in such a system enables increased reaction response time, low sample volume, and reduced reagent cost. It is anticipated that a myriad of further applications will become evident as the technology is refined and developed.

A significant factor in the design of a microfluidic device is the resistance to fluid movement imposed by contact of fluid with surfaces in the microscopic channels of the device. It may be desirable to control the flow of fluid within the microfuidic device so that fluids can flow more readily in one direction than in another direction. In general, reactants should flow into a mircofluidic device at one or more entrances and products should flow out at one or more exits. Backwards flow can sometimes result in contamination of reactants or other problems.

Drainable surfaces are of special interest in commercial and industrial applications for a number of reasons. In nearly any process where a liquid must be dried from a surface, significant efficiencies result if the surface sheds the liquid without heating or extensive drying time. In certain microfluidic applications it may be desirable for fluids to drain from a conduit with greater facility in one direction than an opposing direction. In other situations it may be desirable for fluids to be retained in a certain portion of an apparatus or for their flow rate to be reduced.

It is now well known that surface roughness has a significant effect on the degree of surface wetting. It has been generally observed that, under some circumstances, roughness can cause liquid to adhere more strongly to the surface than to a corresponding smooth surface. Under other circumstances, however, roughness may cause the liquid to adhere less strongly to the rough surface than the smooth surface. In some circumstances, surface roughness may cause the surface to demonstrate directionally biased wetting.

What is needed in the industry is a microfluidic device with fluid flow channels having predictable levels of anisotropic or directionally biased resistance to fluid flow.

### SUMMARY OF THE INVENTION

The invention is a microfluidic device having a durable normophobic or ultraphobic surface that has anisotropic wetting qualities. That is, fluids will demonstrate a variable resistance to flow through a passage depending on the direction in which they flow. The invention substantially meets the needs of the industry for a microfluidic device having fluid flow channels with predictable levels of anisotropic or directionally biased fluid flow resistance. In the invention, all or any portion of the fluid flow channels of any microfluidic device are provided with anisotropic wetting fluid contact surfaces. The anisotropic wetting surface generally includes a substrate portion with a multiplicity of projecting regularly shaped microscale or nanoscale asperities disposed in a regular array

The asperities may be formed in or on the substrate material itself or in one or more layers of material disposed on the surface of the substrate. The asperities may be any regularly or irregularly shaped three dimensional solid or cavity and may be disposed in any regular geometric pattern.

The invention may also include process of making a microfluidic device including steps of forming at least one microscopic fluid flow channel in a body, the fluid flow channel having a fluid contact surface, and disposing a multiplicity of substantially uniformly shaped asperities in a substantially uniform pattern on the fluid contact surface. The asymmetric features can be random or periodic in design. Periodic asperities may vary in two dimensions such as structured stripes, ridges, troughs or furrows. Periodic asperities may also vary in three dimensions such as posts, pyramids, cones or holes. The size, shape, spacing and angles of the asperities can be tailored to achieve a desired anisotropic wetting behavior.

Generally, anisotropic wetting qualities are effective with droplets on surfaces and slugs within tubes, troughs or channels. Surfaces having anisotropic wetting qualities can be used to help ensure that slugs or small droplets of liquid drain fully from the surface or, alternately, can be used to help ensure that droplets are retained so that there is less risk of undesired movement of fluid from one area of a mircofluidic device to another.

Microscale asperities according to the invention may be formed using known molding and stamping methods by texturing the tooling of the mold or stamp used in the process. The processes could include injection molding, extrusion with a textured calendar roll, compression molding tool, or any other known tool or method that may be suitable for forming microscale asperities.

Smaller scale asperities may be formed using photolithography, or using nanomachining, microstamping, microcontact printing, self-assembling metal colloid monolayers, atomic force microscopy nanomachining, sol-gel molding, self-assembled monolayer directed patterning, chemical etching, sol-gel stamping, printing with colloidal inks, or by disposing a layer of carbon nanotubes on the substrate.

It is anticipated that fluid flow channels in a microfluidic device having anisotropic wetting fluid contact surfaces will exhibit reduced resistance to fluid flow in a first direction as opposed to a second direction, leading to greatly improved microfluidic flow control.

### BRIEF DESCRIPTION OF THE DRAWINGS

FIG. 1 depicts a wetting angle formed where a droplet meets a surface;

FIG. 2 depicts examples of advancing contact angle and receding contact angle;

FIG. 3 depicts a sessile droplet on an incline plane;

FIG. 4 depicts a sessile droplet on a vertical surface;

FIG. 5 depicts a sessile droplet on a rotating platter;

FIG. 6 depicts a sessile droplet anchored to a surface by a retention force;

FIG. 7 depicts a slug within an inclined tube;

FIG. 8 depicts a slug acted on by isostatic pressure;

FIG. 9 depicts a slug within an inclined tube also being acted on by isostatic pressure;

FIG. 10 depicts a slug within a tube, an advancing and receding contact angle;

FIG. 11 depicts a sessile droplet on a smooth surface;

FIG. 12 depicts a sessile droplet on a rough surface;

FIG. 13 is a side elevational view of an exemplary symmetrical asperity;

FIG. 14 is a side elevational view of an exemplary symmetrical asperity and an exemplary asymmetrical asperity;

FIG. 15 is a cross sectional view of an exemplary surface with periodic asymmetric asperities that would be expected to demonstrate directionally biased wetting;

FIG. 16 is another cross sectional view of an exemplary surface with periodic asymmetric asperities that would be expected to demonstrate ultraphobic properties and directionally biased wetting;

FIG. 17 is a chart of calculated retentive forces for water slugs in PFA tubes;

FIG. 18 is a graph of retentive force ratio vs. first asperity rise angle for various second asperity rise angles where the difference between advancing contact angle and receding contact angle is fixed at ten degrees;

FIG. 19 is a graph of retentive force ratio vs. first asperity rise angle for various differences between advancing contact angle and receding contact angle where the second asperity rise angle is fixed at ninety degrees

FIG. 20 is an exploded view of a microfluidic device according to the present invention; and

FIG. 21 is a cross-sectional view of an alternative embodiment of a microfluidic device according to the present invention;

### DETAILED DESCRIPTION OF THE INVENTION

For the purposes of the present application, the term “microfluidic device” refers broadly to any other device or component that may be used to contact, handle, transport, contain, process, or convey a fluid, wherein the fluid flows through one or more fluid flow channels of microscopic dimensions. For the purposes of the present application, “microscopic” means dimensions of 500 μm or less. “Fluid flow channel” broadly refers to any channel, conduit, pipe, tube, chamber, or other enclosed space of any cross-sectional shape used to handle, transport, contain, or convey a fluid. The term “fluid contact surface” refers broadly to any surface or portion thereof of a fluid flow channel that may be in contact with a fluid.

It is now well known that surface roughness has a significant effect on the degree of surface wetting. It has been generally observed that, under some circumstances, roughness can cause liquid to adhere more strongly to the surface than to a corresponding smooth surface. Under other circumstances, however, roughness may cause the liquid to adhere less strongly to the rough surface than the smooth surface. In some circumstances, the surface may be ultraphobic. Such an ultraphobic surface generally takes the form of a substrate member with a multiplicity of microscale to nanoscale projections or cavities, referred to herein as “asperities”.

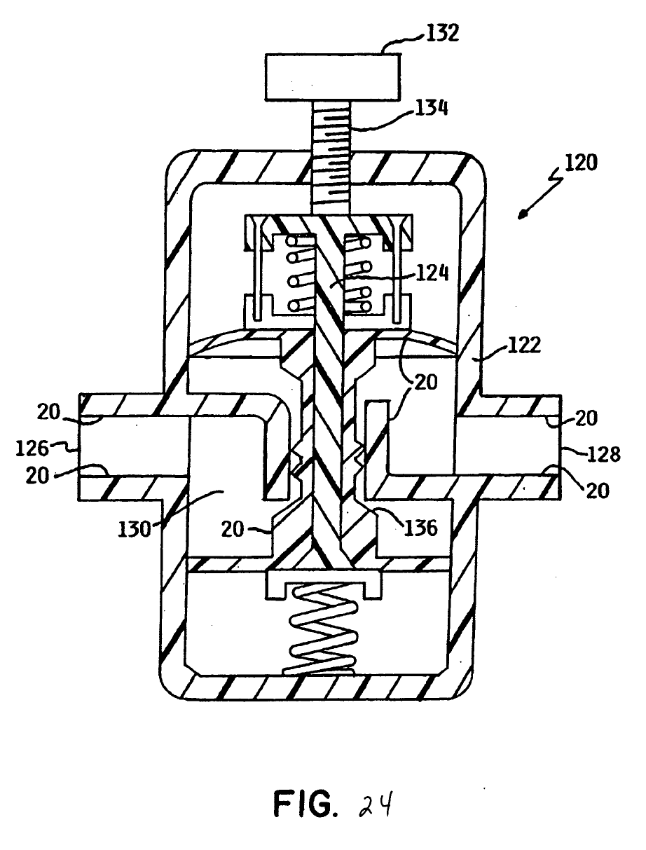

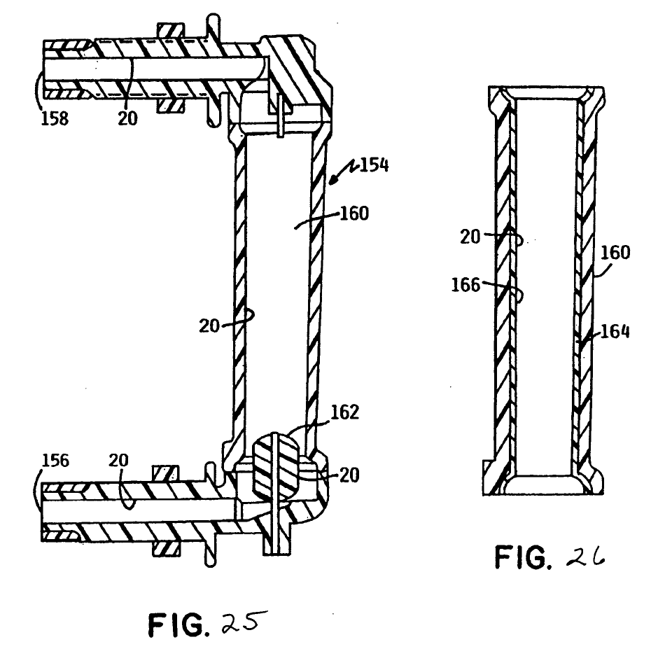

A microfluidic device 110 according to the present invention is depicted in a greatly enlarged, exploded view in FIG. 20. Device 110 generally includes a body 111 with a rectangular flow channel 112 formed therein. Body 111 generally includes a main portion 113 and a cover portion 114. Flow channel 112 is defined on three sides by inwardly facing surfaces 115 on main portion 113 and on a fourth side by an inwardly facing surface 116 on cover portion 114. Surfaces 115 and surface 116 together define channel wall 116a.

According to the present invention, all or any desired portion of channel wall 116a may be provided with an anisotropic wetting fluid contact surface 120. Although a two-piece configuration with rectangular flow channel is depicted in FIG. 20, it will of course be readily appreciated that microfluidic device 110 may be formed in any other configuration and with virtually any other flow channel shape or configuration, including a one piece body 111 with a cylindrical, polygonal, or irregularly shaped flow channel formed therein.

An alternative embodiment of a microfluidic device is depicted in cross-section in FIG. 21. In this embodiment, body 200 is formed in one integral piece. Cylindrical flow channel 202 is defined within body 200, and has a channel wall 204 presenting anisotropic wetting fluid contact surface 20 facing into flow channel 202.

An enlarged view of exemplary directionally biased wetting surfaces 30 is depicted in FIGS. 15 and 16. A directionally biased wetting surface 30 generally includes substrate 32 and a multiplicity of projecting asperities 34.

Each asperity 34 in this example protrudes from substrate 32. Asperities 34 may also be indentations into substrate 32.

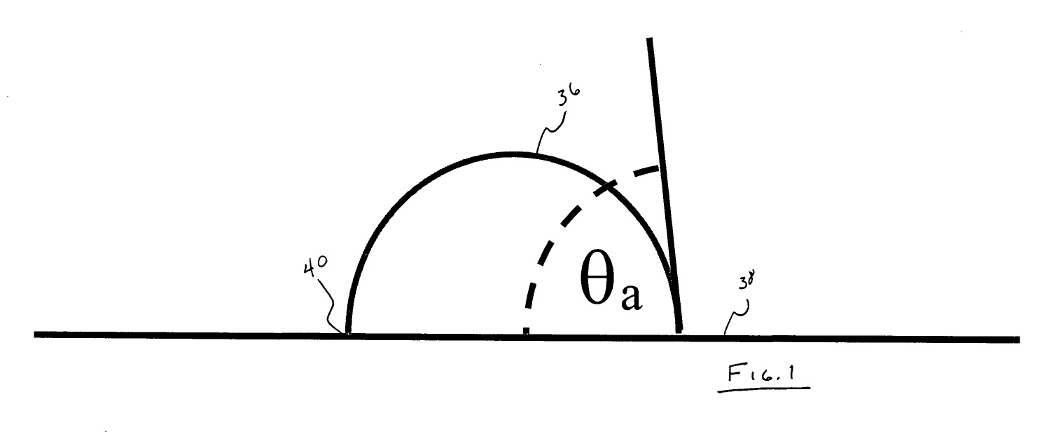

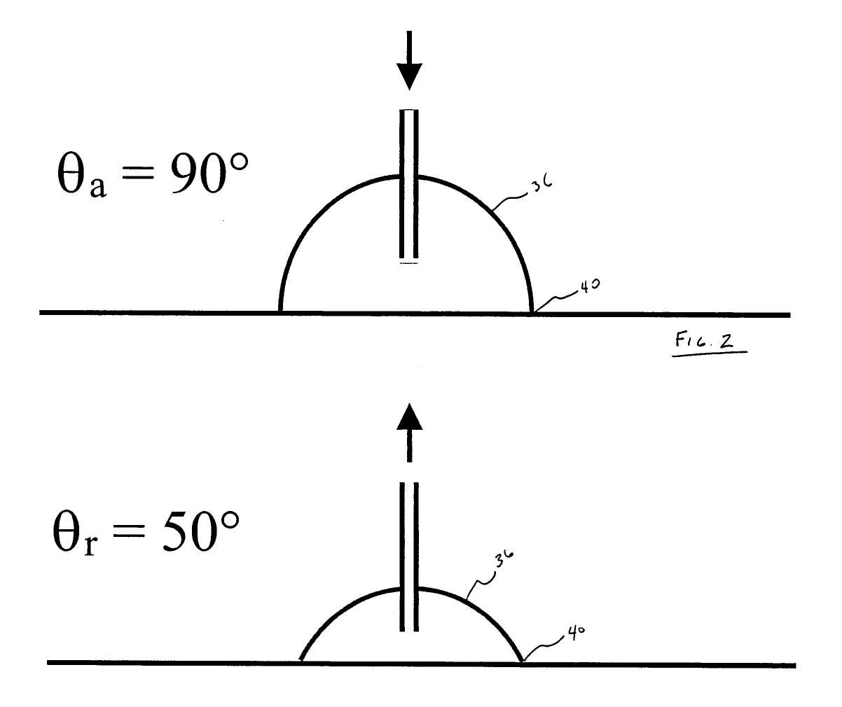

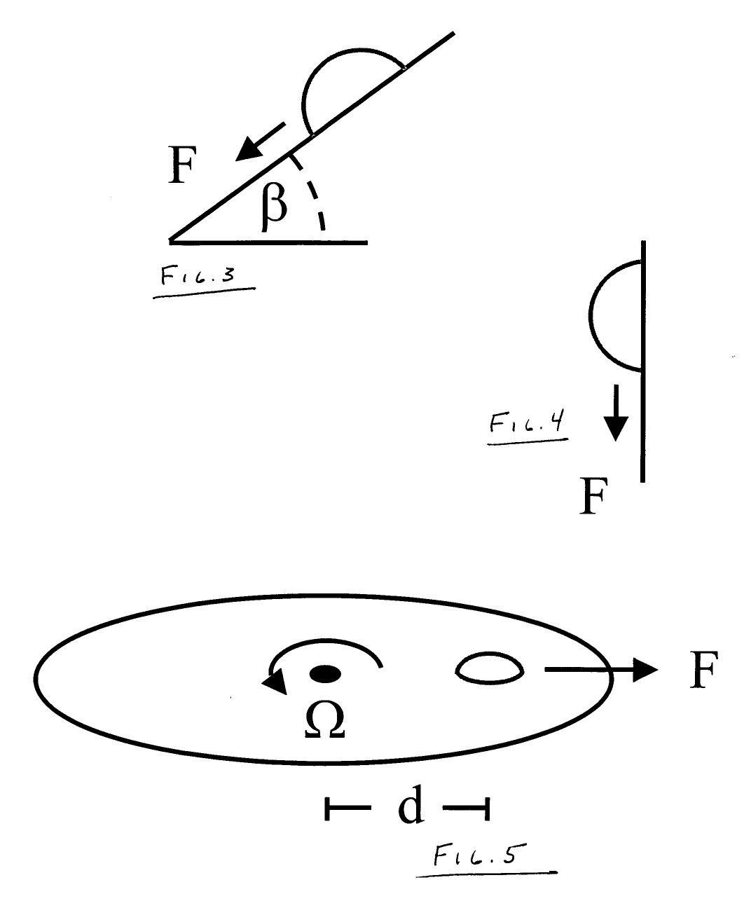

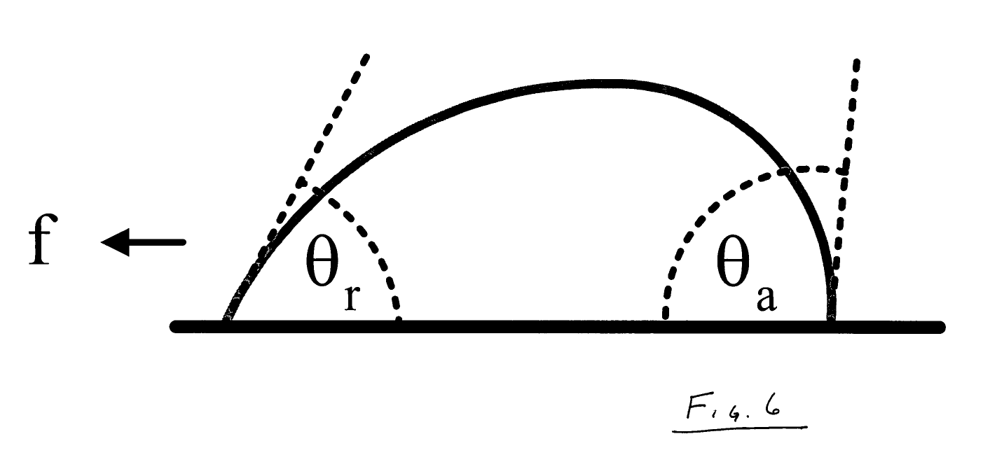

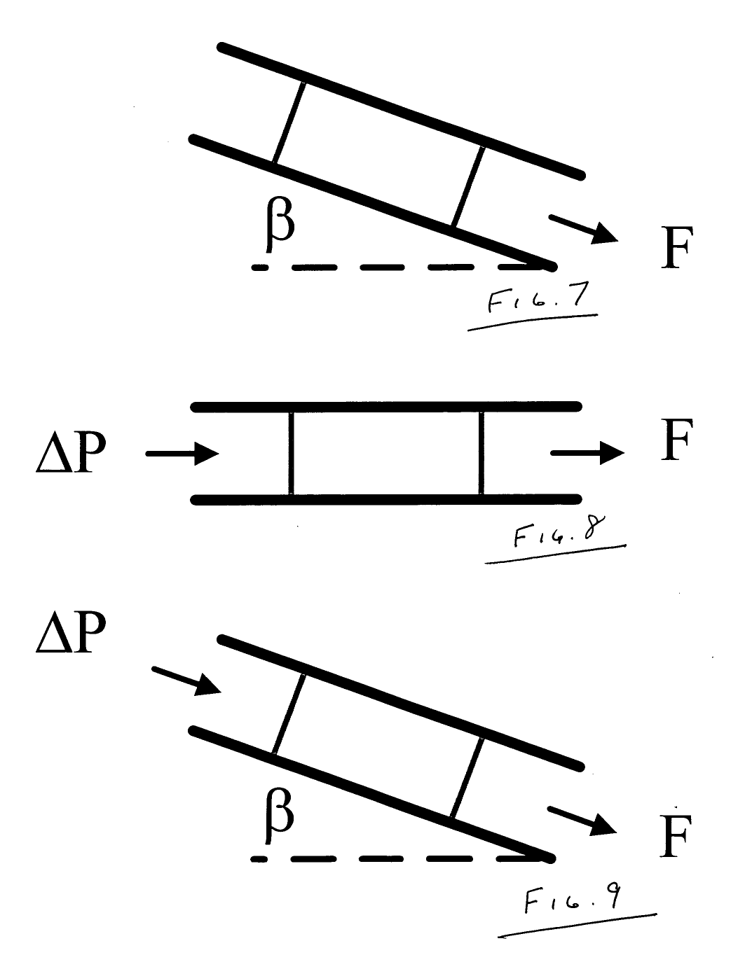

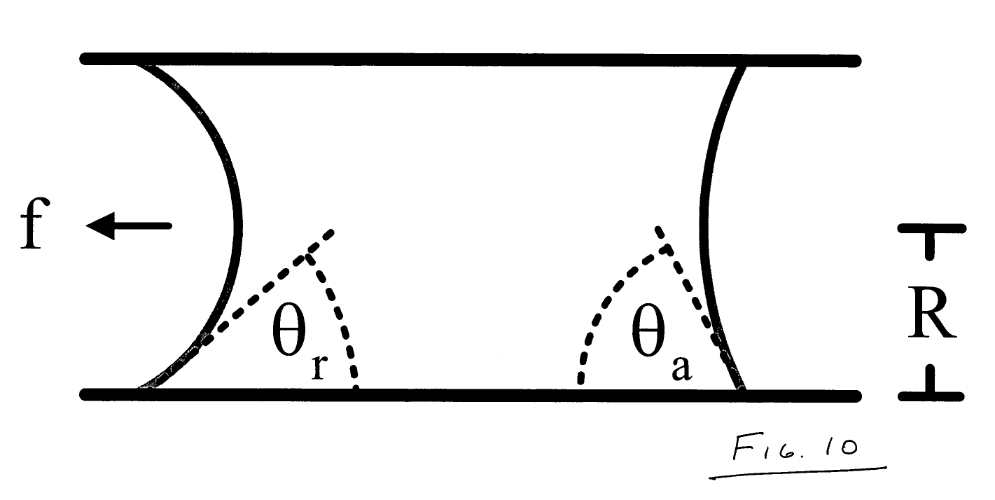

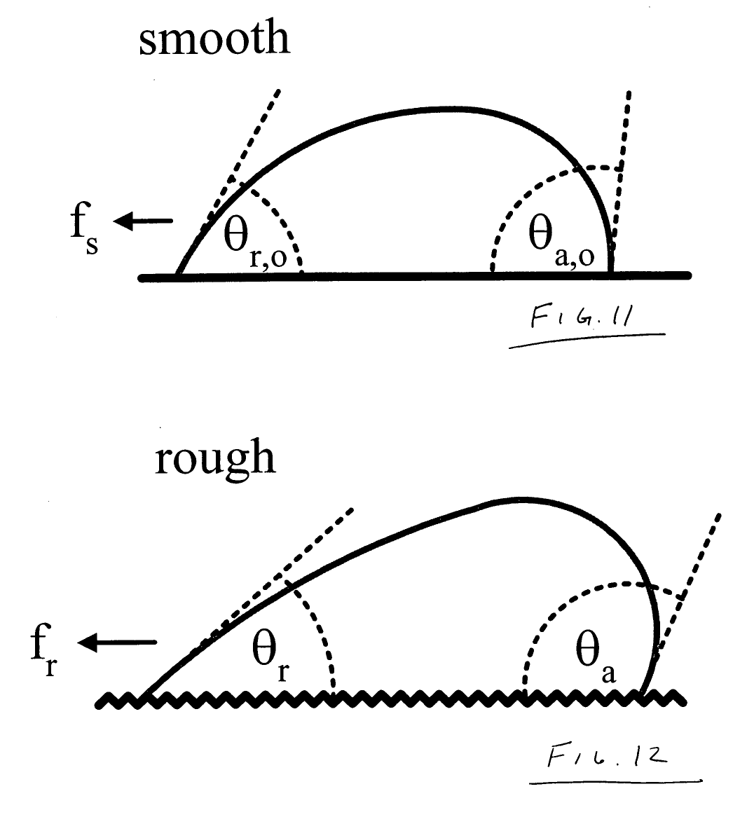

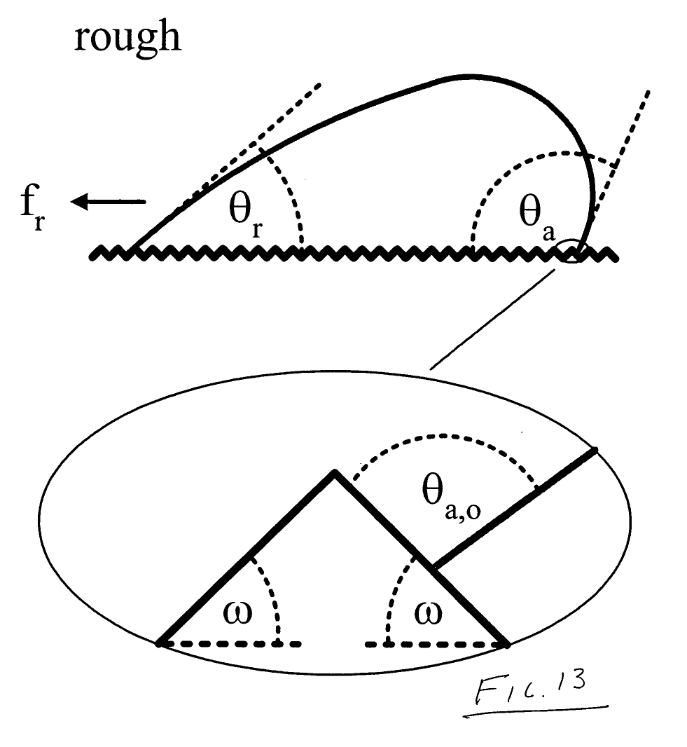

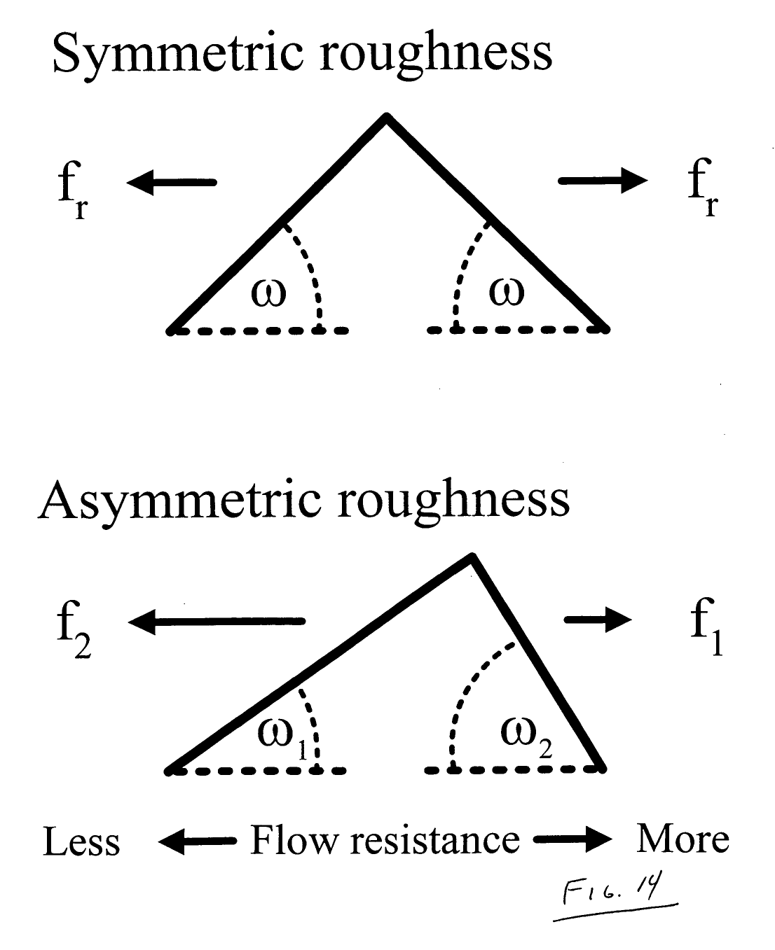

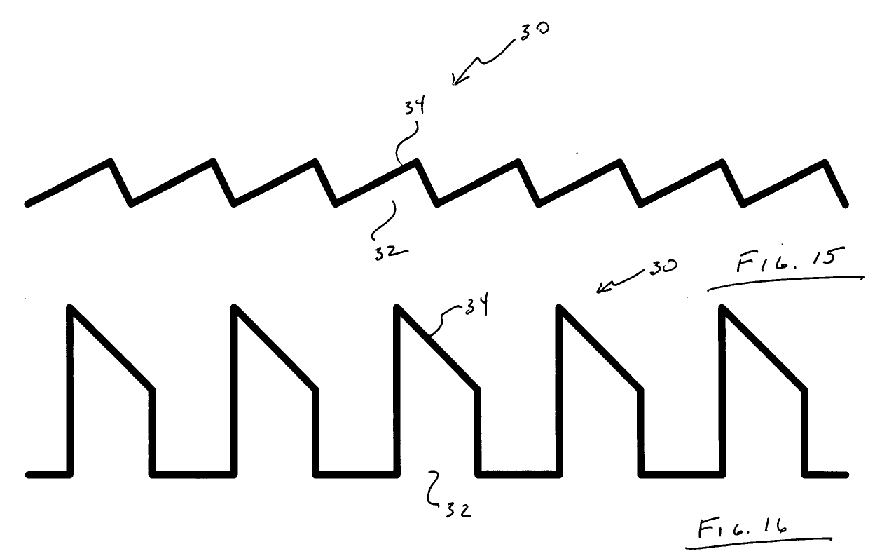

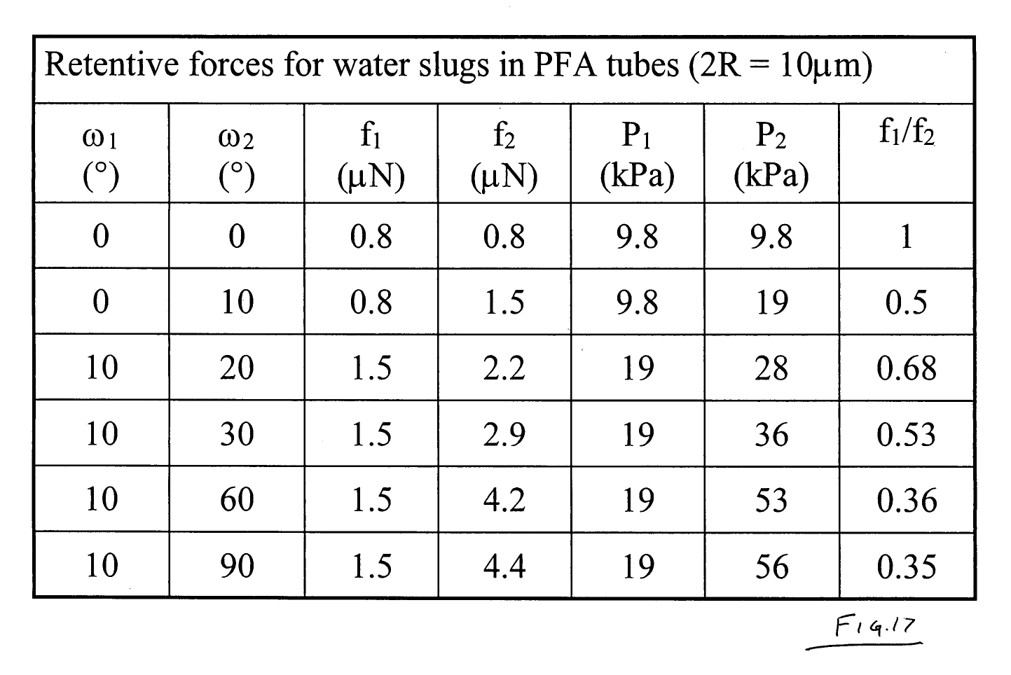

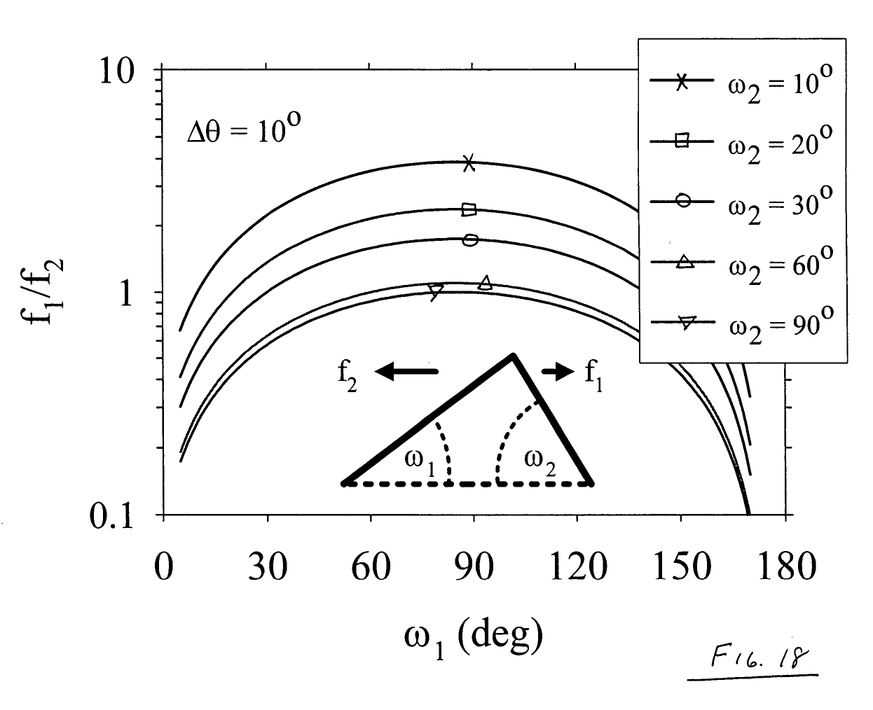

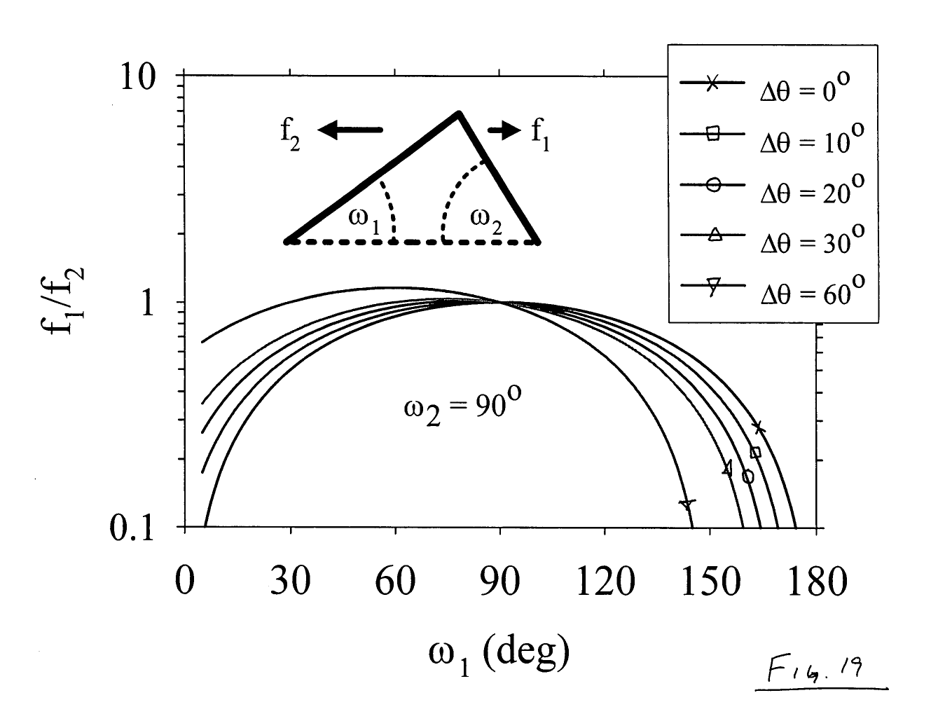

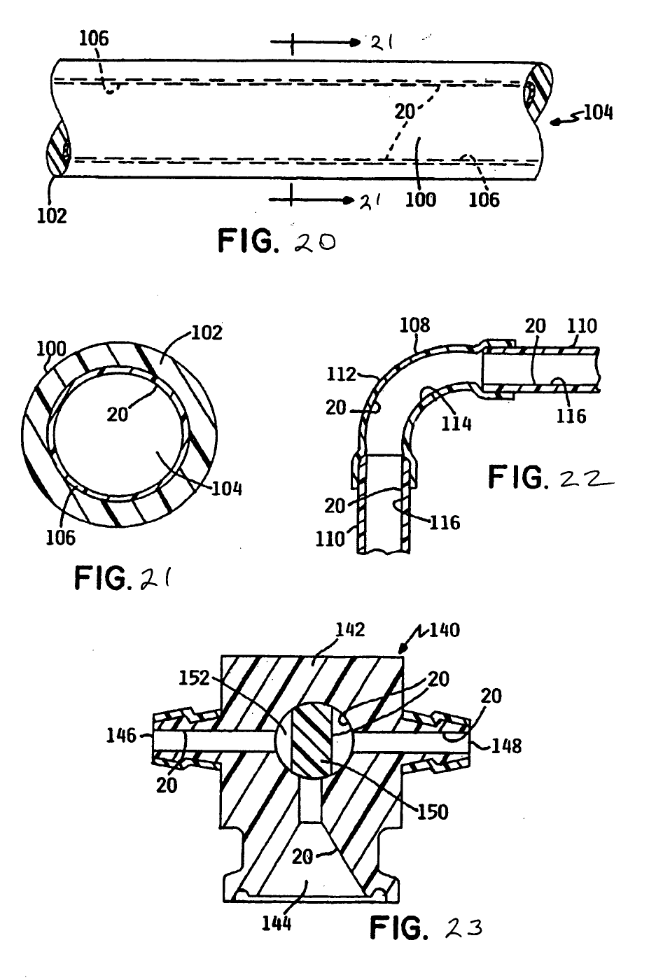

Referring to FIG. 1, a droplet 36 meets a surface 38 at a contact angle annotated θ. Contact angle is affected by hysteresis. When the contact line 40 between the droplet 36 and the surface 38 advances contact angle decreases. Referring to FIG. 2, when an example droplet 36 increases in size because fluid is added, the contact line 40 advances and the advancing contact angle θₐ is equal to about ninety degrees. When the example droplet 36 decreases in size, because fluid is removed, the contact line 40 recedes and the receding contact angle θᵣ equals about fifty degrees. The receding contact angle θᵣ is less than the advancing contact angle θₐ.

Hysteresis can be defined as:
Δθ=θₐ−θᵣ

Hysteresis is caused by molecular interactions, surface impurities, heterogeneities and surface roughness.

In order to better understand the present invention, it is helpful to consider the following cases: Retention of sessile drops by flat surfaces; retention of a liquid slug by a cylindrical tube; and wetted rough surfaces which demonstrate increased liquid-solid adhesion. Wetted rough surfaces include surfaces having symmetric roughness which generally demonstrate isotropic wetting and surfaces demonstrating asymmetric roughness which demonstrate directionally biased wetting.

For sessile drops, body forces, annotated F, are considered to be the forces acting on the Sessile drops tending to cause it to move along a surface. Body forces may arise from gravity, centrifugal forces, pressure differences or other forces.

Referring to FIG. 3, a sessile droplet is depicted on an incline plane. For this situation body forces are defined by the equation,
F=ρgV·sinβ

where

ρ=density,

g=the acceleration of gravity,

V=the volume of the drop, and

β=the angle of the incline plane.

Referring to FIG. 4, a sessile droplet on vertical surface is depicted. For this situation the acceleration of gravity acts parallel to the surface and sinβ equals one, so the body force
F=ρgV.

Referring to FIG. 5 for a sessile droplet on a rotating platter
F=ρVΩ²d,

where

ρ=density,

V=volume of the drop;

Ω=angular velocity, and

d=distance of the droplet from the center of rotation.

Referring to FIG. 6, for sessile drops, retention force, annotated f, anchors the sessile drop in position if the surface forces are greater than body forces. Retention force is defined by the equation:
f=kγR·Δcosθ,

where

γ=liquid surface tension,

2R=drop width,

k=4/π for circular drops, and

k>4/π for elliptical drops, and

Δ=(cosθᵣ−cosθₐ).

Referring to FIG. 7, when considering the body forces affecting a cylindrical liquid slug in a tube, for an inclined tube, body forces
F=ρgV·sinβ,

where

ρ=density of the liquid,

g=the acceleration of gravity,

V=the volume of the slug, and

β=angle of inclination.

Referring to FIG. 8, when considering the body forces affecting a cylindrical slug affected by isostatic pressure
F=AΔP=πR²ΔP,

where

A=area,

ΔP=differential isostatic pressure,

R=radius of the cylindrical slug.

Referring to FIG. 9, when a slug is acted on by a combination of isostatic pressure and gravity in an inclined tube
F=ρgV·β+πR²ΔP.

Now, referring to FIG. 10, retention force (f) anchors a slug in position if surface forces are greater than body forces.
f=kγR·Δcosθ,

where

γ=liquid surface tension,

R=drop/tube radius,

k=2π for slugs,

Δθ=(cosθᵣ−COSθₐ).

To summarize, retention force
f=kγR·Δθ

where

k=4/π for sessile drops

k=2π for slugs,

γ=liquid surface tension,

R=drops/tube radius,

Δθ=(cos θᵣ−COSθₐ).

Now, referring to FIGS. 11 and 12, we consider the effect of surface roughness on adhesion or retention of droplets. As can be seen in FIG. 12, when a droplet is placed on a rough surface, the liquid of the droplet is impaled by the asperities 34 on the surface. Because of the interaction of the asperities 34 with the contact line 40, the advancing contact angle intermittently increases as compared to a flat surface and the receding contact angle intermittently decreases as compared to a flat surface. Thus, the force to move the drops along a rough surface is much greater than for a corresponding smooth surface.

For rough surfaces one can consider the geometric interaction of the droplet with the asperities 34 in the following equations.
θₐ=θ_{a,0}+ω,
θᵣ=θ_{r,0}−ω,

Thus, for smooth surfaces, the retention force
fₛ=kγR(cosθ_{r,0}−θ_{a,0}).

For rough surfaces, the retention force
fᵣ=kγR[(θ_{r,0}−ω)−(θ_{a,0}+ω)].

### EXAMPLE

Referring to FIG. 13, it is then possible to compare the retentive forces of comparable rough surfaces and smooth surfaces. For example, we will assume a small Sessile water drop on a surface of formed from PFA or PTFE where

k=4/π, γ=72 mN/m,

2R=2 mm,

θ_{a,0}=110°,

θ_{r,0}=90°

and we will consider the variation in roughness (ω). Referring to FIG. 17, it can be seen that retention force fₛ for a smooth surface is substantially less than the retention force fᵣ for rough surfaces. In addition, with increasing values of ω, the retention force increases dramatically.

Thus, symmetric roughness leads to isotropic wetting because the value of fᵣ is equal in symmetric directions.

Referring to FIG. 14, asymmetric roughness can be shown to cause directionally biased wetting. This is also known as anisotropic wetting. Anisotropic wetting occurs because of the difference in retentive force created by asymmetric roughness:
f₁−f₂=kγR[(θ_{r,0}−ω₁)−(θ_{a,0}+ω₁)−(θ_{r,0}−ω₁)+(θ_{a,0}+ω₁)].

Thus, it is possible to calculate a retentive force ratio (f₁/f₂) caused by asymmetric roughness.
f₁/f₂=(ω₁+1/2Δθ₀)/sin(ω₂+1/2Δθ₀),
where
Δθ₀=(θ_{a,0}−θ_{r,0}).

Thus, it is possible to compare the retentive forces on drops caused by asymmetric roughness. For this example we will assume a small sessile water drop on a PFA or PTFE surface. In this case k=4/π, y=72 mN/m, 2R=2 mm, θ_{a,0}=100°, θ_{r,0}=90° and we will vary the values of ω₁ and ω₂. The results of this calculation can be found in a table at FIG. 18.

Referring to FIG. 18, it can be seen that the ratio of f₁/f₂ varies considerable from a smooth surface and for surfaces of various roughnesses.

It is also possible to compare the retentive forces related to slugs in a cylindrical tube. For this example we will assume a small water slug in PFA tube wherein

k=2π,

γ=72 mN/m,

2R=10 μm,

θ_{a,0}=100°,

θ_{r,0}=90°.

When we vary the values of ω₁ and ω₂. The results of this calculation can be seen in the table depicted in FIG. 17.

When these results are graphed, referring to FIG. 18, it can be seen that the quotient of f₁ divide by f₂ varies with changes in ω₁ reaching a maximum at about ninety degrees and declining as ω₁ approaches zero and one hundred eighty degrees.

In addition, referring to FIG. 19, results can be seen when Δθ is varied the second asperity rise angle is fixed.

This understanding can be applied to the manufacture of microfluidic devices. It is often desirable that when liquids are emptied from a fluid flow channel that all fluid consistently exit the channel for accuracy of measurement and to avoid retention of fluids that may contaminate future samples. It can be seen that the above-discussed mathematical relationships can be utilized to design a surface profile that includes asymmetric asperities that will minimize retention forces that tend to retain droplets or slugs within the channel.

Alternately, it may be desirable to design a fluid flow channel in a microfluidic device that has maximized retention force in a certain orientation. Here an anisometric wetting surface may be designed to retain droplets or slugs until it is desired to discharge them by applying additional force to them such as by gas pressure or centrifugal force. In essence a check valve may be formed in an open fluid flow passage by the use of anisotropic wetting surfaces.

Generally, the substrate material from which the fluid handling device is made may be any material upon which micro or nano scale asperities may be suitably formed. The asperities may be formed directly in the substrate material itself, or in one or more layers of other material deposited on the substrate material, by photolithography or any of a variety of suitable methods. Microscale asperities according to the invention may be formed using known molding and stamping methods by texturing the tooling of the mold or stamp used in the process. The processes could include injection molding, extrusion with a textured calendar roll, compression molding tool, or any other known tool or method that may be suitable for forming microscale asperities. For example, a silicone rubber mold such as is traditionally used for molding microfluidic devices may have asymmetric features formed on the flow channel molding surfaces.

Other methods that may be suitable for forming smaller scale asperities of the desired shape and spacing include nanomachining as disclosed in U.S. Patent Application Publication No. 2002/00334879, microstamping as disclosed in U.S. Pat. No. 5,725,788, microcontact printing as disclosed in U.S. Pat. No. 5,900,160, self-assembled metal colloid monolayers, as disclosed in U.S. Pat. No. 5,609,907, microstamping as disclosed in U.S. Pat. No. 6,444,254, atomic force microscopy nanomachining as disclosed in U.S. Pat. No. 5,252,835, nanomachining as disclosed in U.S. Pat. No. 6,403,388, sol-gel molding as disclosed in U.S. Pat. No. 6,530,554, self-assembled monolayer directed patterning of surfaces, as disclosed in U.S. Pat. No. 6,518,168, chemical etching as disclosed in U.S. Pat. No. 6,541,389, or sol-gel stamping as disclosed in U.S. Patent Application Publication No. 2003/0047822, all of which are hereby fully incorporated herein by reference. Carbon nanotube structures may also be usable to form the desired asperity geometries. Examples of carbon nanotube structures are disclosed in U.S. Patent Application Publication Nos. 2002/0098135 and 2002/0136683, also hereby fully incorporated herein by reference. Also, suitable asperity structures may be formed using known methods of printing with colloidal inks. Of course, it will be appreciated that any other method by which micro/nanoscale asperities may be accurately formed may also be used. A photolithography method that may be suitable for forming micro or nano scale asperities is disclosed in PCT Patent Application Publication WO 02/084340, hereby fully incorporated herein by reference.

Anisotropic wetting surface principals can be applied to ultraphobic surfaces as well. ultraphobic wetting surface are described in the following U.S. Patents and U.S. Patent Applications which are incorporated in their entirety by reference. U.S. patent application Ser. Nos. 10/824,340; 10/837,241; 10/454,743; 10/454,740 and U.S. Pat. No. 6,845,788. The disclosures of the above referenced Applications and Patent can be utilized along with the present application to design surface that demonstrate both and anisotropic wetting and ultraphobic properties.

It will also be appreciated that a wide variety of asperity shapes and arrangements are possible within the scope of the present invention. For example, asperities may be polyhedral, cylindrical, cylindroid, or any other suitable three dimensional shape.

The asperities may be arranged in a rectangular array as discussed above, in a polygonal array such as the hexagonal array depicted in FIGS. 4-5, or a circular or ovoid arrangement.

The present invention may be embodied in other specific forms without departing from the central attributes thereof, therefore, the illustrated embodiments should be considered in all respects as illustrative and not restrictive, reference being made to the appended claims rather than the foregoing description to indicate the scope of the invention.

What is claimed is:

1. A microfluidic device comprising:
a body having at least one microscopic fluid flow channel therein, the microscopic fluid flow channel being defined by a channel wall having a fluid contact surface portion, said fluid contact surface portion comprising a substrate having a surface with a multiplicity of asymmetric substantially uniformly shaped asperities thereon, each asperity having a first asperity rise angle and a second asperity rise angle relative to the substrate, the asperities being structured to meet a desired retentive force ratio (f₁/f₂) caused by asymmetry between the first asperity rise angle and the second asperity rise angle according to the formula:
f₁/f₂=(ω₁+1/2Δθ₀)/sin(ω₂+1/2Δθ₀), Δθ₀=(θ_{a,0}−θ_{r,0})
where ω₁ is the first asperity rise angle in degrees;
ω₂ is the second asperity rise angle in degrees;
Δθ₀=(θ_{a,0}−θ_{r,0});
θ_{a,0} is the advancing contact angle in degrees; and
θ_{r,0} is the receding contact angle in degrees.

2. The device of claim 1, wherein the asperities are projections.

3. The device of claim 2, wherein the asperities are polyhedrally shaped.

4. The device of claim 2, wherein each asperity has a generally square cross-section.

5. The device of claim 2, wherein the asperities are cylindrical or cylindroidally shaped.

6. The device of claim 1, wherein the asperities are cavities formed in the substrate.

7. The device of claim 1, wherein the asperities are parallel ridges.

8. The device of claim 7, wherein the parallel ridges are disposed transverse to a direction of fluid flow.

9. A process of making a microfluidic device comprising steps of:
forming at least one microscopic fluid flow channel in a body, the fluid flow channel being defined by a channel wall formed from a substrate having a fluid contact surface portion; and
forming a multiplicity of substantially uniformly shaped asperities on the fluid contact surface portion, each asperity having a first asperity rise angle and a second asperity rise angle relative to the substrate,
selecting the structure of the asperities to meet a desired retentive force ratio (f₁/f₂) caused by asymmetry between the first asperity rise angle and the second asperity rise angle according to the formula:
f₁/f₂=(ω₁+1/2Δθ₀)/sin(ω₂+1/2Δθ₀), Δθ₀=(θ_{a,0}−θ_{r,0})
where ω₁ is the first asperity rise angle in degrees;
ω₂ is the second asperity rise angle in degrees;
Δθ₀=(θ_{a,0}−θ_{r,0})
θ_{a,0} is the experimentally determined true advancing contact angle in degrees; and
θ_{r,0} is the experimentally determined true receding contact angle in degrees.

10. The process of claim 9, wherein the asperities are formed by a process selected from the group consisting of nanomachining, microstamping, microcontact printing, self-assembling metal colloid monolayers, atomic force microscopy nanomachining, sol-gel molding, self-assembled monolayer directed patterning, chemical etching, sol-gel stamping, printing with colloidal inks, and disposing a layer of carbon nanotubes on the surface.

11. The process of claim 9, wherein the asperities are formed by extrusion.

12. The process of claim 9, further comprising the step of selecting a geometrical shape for the asperities.

13. The process of claim 9, further comprising the step of selecting an array pattern for the asperities.

14. A microfludic fluid flow system including at least one microfluidic device, the device comprising:
a body having at least one microscopic fluid flow channel therein, the microscopic fluid flow channel being defined by a channel wall having a fluid contact surface portion, said fluid contact surface portion comprising a substrate with a multiplicity of substantially uniformly shaped and dimensioned asperities thereon, said asperities arranged in a substantially uniform pattern, each asperity having a first asperity rise angle and a second asperity rise angle relative to the substrate, the asperities being structured to meet a desired retentive force ratio (f₁/f₂) caused by asymmetry between the first asperity rise angle and the second asperity rise angle according to the formula:
f₁/f₂=(ω₁+1/2Δθ₀)/sin(ω₂+1/2Δθ₀), Δθ₀=(θ_{a,0}−θ_{r,0})
where ω₁ is the first asperity rise angle in degrees;
ω₂ is the second asperity rise angle in degrees;
Δθ₀=(θ_{a,0}−θ_{r,0});
θ_{a,0} is the advancing contact angle in degrees; and
θ_{r,0} is the receding contact angle in degrees.

15. The system of claim 14, wherein the asperities are projections.

16. The system of claim 14, wherein the asperities are polyhedrally shaped.

17. The system of claim 16, wherein each asperity has a generally square cross-section.

18. The system of claim 14, wherein the asperities are cylindrical or cylindroidally shaped.

19. The device of claim 14, wherein the asperities are cavities formed in the substrate.

20. The device of claim 14, wherein the asperities are parallel ridges.

21. The device of claim 20, wherein the parallel ridges are disposed transverse to the direction of fluid flow.
